(19) United States
(12) Patent Application Publication
(10) Pub. No.: US 2024/0410649 A1
(43) Pub. Date: Dec. 12, 2024

(54) INSTALLATION AND A METHOD FOR COOLING A FLUID TO CRYOGENIC TEMPERATURE

(71) Applicant: L'Air Liquide, Societe Anonyme pour l'Etude et l’Exploitation des Procedes Georges Claude, Paris (FR)

(72) Inventors: Marine ANDRICH, Champigny-Sur-Marne (FR); Ludovic GRANADOS, Champigny-Sur-Marne (FR); Baptiste PAGES, KOBE (JP); Emeline VANDROUX, Sassenage (FR); Pierre BARJHOUX, Sassenage (FR); Bhadri PRASAD, Champigny-Sur-Marne (FR)

(73) Assignee: L'Air Liquide, Societe Anonyme pour l'Etude et l’Exploitation des Procedes Georges Claude, Paris (FR)

(21) Appl. No.: 18/740,952

(22) Filed: Jun. 12, 2024

(30) Foreign Application Priority Data
Jun. 12, 2023 (FR) FR 2305892

(51) Int. Cl. F25J 1/02; F25J 1/00

(52) U.S. Cl. CPC F25J 1/0262; F25J 1/001; F25J 1/0052; F25J 1/0065; F25J 1/0067; F25J 1/0072; F25J 1/0075; F25J 1/0082; F25J 1/0203; F25J 1/0245; F25J 2205/82; F25J 2240/02; F25J 2240/40; F25J 2270/12; F25J 2290/34

(57) ABSTRACT

The invention relates to an installation for producing liquefied gas comprising a circuit for supplying feed gas, a set of heat exchangers, a refrigerator for cooling some or all of the set of heat exchangers, the supply circuit comprising, between the set of heat exchangers and the downstream end thereof, a final expansion turbine for expanding the feed gas in liquid state, the supply circuit comprising a bypass line of the final expansion turbine fitted with a first expansion valve, a second expansion valve disposed in series upstream or downstream of the first expansion valve and of the final expansion turbine, an additional heat exchange line designed to exchange heat with a heat exchanger of the set of heat exchangers when the feed gas is expanded by the first expansion valve via the bypass line, the additional heat exchange line carrying out this heat exchange with said heat exchanger between the expansion carried out by the first expansion valve and the expansion carried out by the second expansion valve, the additional heat exchange line being located upstream or respectively downstream of the expansion carried out by the first expansion valve.

### CROSS REFERENCE TO RELATED APPLICATIONS

This application claims the benefit of priority under 35 U.S.C. § 119 (a) and (b) to French patent application No. FR2305892, filed Jun. 12, 2023, which is herein incorporated by reference in its entirety.

### FIELD OF THE INVENTION

The invention relates to an installation and a method for cooling a fluid to cryogenic temperature.

The invention relates more specifically to an installation for producing cryogenic liquefied gas, for example liquefied hydrogen, comprising a circuit for supplying feed gas to be cooled, the supply circuit comprising an upstream end intended to be connected to a gas source and a downstream end intended to be connected to at least one cryogenic store designed to collect and store the liquefied gas, the installation comprising a set of heat exchangers in heat exchange with the supply circuit, the installation comprising at least one cooling device in heat exchange with some or all of the set of heat exchangers, the at least one cooling device comprising a cryogenic refrigerator with a cycle gas comprising at least one of the following: helium, hydrogen, neon, nitrogen, oxygen or methane, the downstream end of the supply circuit comprising, between the set of heat exchangers and the second end intended to be connected to the store, a final expansion turbine designed to expand the feed gas that is in liquid state at the inlet of said turbine, the supply circuit further comprising a bypass line of the final expansion turbine fitted with a first expansion valve, preferably a Joule-Thomson valve, the supply circuit comprising a second expansion valve, preferably a Joule-Thomson valve, disposed in series upstream or respectively downstream of the first expansion valve and of the final expansion turbine, the supply circuit comprising an additional heat exchange line designed to exchange heat with a heat exchanger of the set of heat exchangers when the feed gas is expanded by the first expansion valve via the bypass line.

### BACKGROUND OF THE INVENTION

Producing a subcooled liquefied fluid efficiently combats heat inputs and the generation of gases resulting from vaporization of saturated liquid (boil-off gas) throughout a distribution chain. This is because a subcooled liquid subjected to unwanted heat inputs is initially heated while still in the liquid phase, before vaporising once the boiling point has been reached. The invention thus notably relates to a liquefactor delivering a subcooled liquid, which may for example be hydrogen, helium, carbon dioxide, air, nitrogen, oxygen, and/or a mixture including some of these molecules. Subcooling a fluid such as liquid hydrogen has a higher energy cost than a liquefactor delivering saturated liquid because subcooling induces a temperature below the saturation temperature (efficiency in relation to an ideal Carnot engine).

The invention relates in particular to applications such as liquefaction units where subcooled production is required. The invention notably relates to installations for liquefying components with a liquefaction temperature below −200° C., since the list of usable molecules is limited (typically hydrogen or helium for liquefaction).

Liquefaction units, in particular hydrogen liquefactors, usually liquefy gas using a two-step process: 1) Cooling and/or liquefaction of the product using one or more closed-loop cooling cycles and 2) final expansion of the product using an expansion system to a pressure close to atmospheric pressure (typically from 15 to 30 or 40 bara before expansion to 1.5 to 3 bara after expansion).

The composition of the cooling cycle gas in step 1 is usually either close to the product itself (usually hydrogen, typically with a content of at least 90% by moles) or a more lightweight chemical element (usually more than 20% helium by moles). In the first case, the product obtained after expansion is usually a saturated liquid, whereas the second case enables a subcooled liquid to be produced.

It is usually preferable to produce the subcooled liquid without having to use a “lightweight” final cooling cycle as described above (as this is usually more costly and more difficult to implement).

Liquefaction units (for example units producing liquefied nitrogen, liquefied hydrogen, or helium) are supplied by at least one closed-loop cycle with a fluid usually composed of the product to be liquefied (with a purity of up to 90% by moles or greater than 99% by moles). The refrigeration cycle is made up of compressors, (turbo) expanders and expanders such as valves and/or turbines.

The final step of the cooling cycle is usually carried out by an expansion valve (Joule-Thomson) producing a saturated liquid at low pressure (close to ambient pressure, typically between 0.05 and 0.2 MPaG). This sets the low temperature point of the method.

The feed gas to be cooled/liquefied is cooled by the cooling cycle using a heat exchanger to a minimum temperature greater than the aforementioned low temperature point as a result of the temperature differential between the inlet and the outlet of a heat exchanger ensuring a heat exchange between two fluids (typically a difference of between 0.5° C. and 3° C.).

The feed gas is then expanded through a Joule-Thomson valve to a pressure close to atmospheric pressure (typically close or equal to the low pressure of the cooling cycle). The expanded product is saturated and the vapour phase thereof is separated in a tank. The saturated liquid is made available and the saturated gas is recycled in the method.

Different solutions are available for this final expansion: Joule-Thomson valve and/or turbine to expand the product in liquid state.

See for example the article “Integrated Design for Demonstration of Efficient Liquefaction of Hydrogen (IDEALHY)” (authors K. Stolzenburg and R. Mubbala (Hydrogen Liquefaction Report D3.16). See also US2010272634A or CN107014151.

The production of saturated liquid imposes several limitations on the use of the product. Flash gas may form in the distribution pipes as a result of the pressure drop and the ingress of heat. This induces a two-phase flow, the physical properties of which complicate circuit design (increased risk of vibration).

Where there is a high hydrostatic pressure difference between the liquid production point and the top of the liquid storage tank, additional flash gas may be produced from the product, increasing the liquid product loss.

A final expansion turbine for the liquefied feed gas enables sufficient subcooling to prevent or limit flash gas or unity during reduced operation.

However, if this turbine is unavailable (for example during maintenance work), replacing it with a back-up expansion valve makes it difficult to achieve the thermodynamic conditions required at the outlet of the liquefactor.

### SUMMARY OF THE INVENTION

One aim of the present invention is to overcome all or some of the aforementioned drawbacks of the prior art.

For this purpose, the installation according to certain embodiments of the invention can include an additional heat exchange line that is designed to carry out this heat exchange with said heat exchanger between the expansion carried out by the first expansion valve and the expansion carried out by the second expansion valve, the additional heat exchange line being located upstream or respectively downstream of the expansion carried out by the first expansion valve.

Furthermore, embodiments of the invention may include one or more of the following features:
the heat exchanger in heat exchange with the additional heat exchange line is the end exchanger of the set of heat exchangers in series, of which an outlet is connected to the inlet of the final expansion turbine,
the supply circuit forms two successive distinct passes through the end exchanger of the set of exchangers, the additional heat exchange line constituting one of the two passes,
the supply circuit comprises, disposed in series in this order from upstream to downstream: a first of the two passes through the end exchanger, the second expansion valve, the second of the two passes through the end exchanger, the final expansion turbine with the bypass line thereof fitted with the first expansion valve, and the second end,
the supply circuit comprises, disposed in series in this order from upstream to downstream: a first of the two passes through the end exchanger, the final expansion turbine with the bypass line thereof fitted with the first expansion valve, the second of the two passes through the end exchanger, the second expansion valve, and the second end,
the supply circuit comprises, between the final expansion turbine and the bypass line thereof on one side and the second of the two passes through the end exchanger on the other side, a bypass line designed to recover the fluid at the outlet of the final expansion turbine without passing through the second of the two passes through the end exchanger,
the installation is designed to produce liquefied hydrogen, the supply circuit comprising at least one catalysis section designed to convert the ortho-hydrogen into para-hydrogen, the catalysis section being located in at least one of the two passes through the end exchanger, for example in the first pass and/or outside the end exchanger, at the outlet of one of the two passes through the end exchanger,
the supply circuit comprises a third expansion valve, preferably a Joule-Thomson valve, disposed in series with the first and second expansion valves,
the third expansion valve is disposed downstream or upstream of the first expansion valve,
the installation comprises a regulating member disposed at the inlet of the final expansion turbine and designed to regulate the pressure and/or flow rate in the supply circuit and/or the rotation speed of said turbine, the bypass line of the expansion turbine also bypassing this regulating member,
the installation comprises a control system designed to switch the installation to a first operating mode in which the bypass line is closed and liquefied cryogenic fluid is produced via an expansion in the final expansion turbine, and to a second operating mode in which the bypass line is open and the final expansion turbine is stopped and liquefied cryogenic fluid is produced via a double expansion via the first expansion valve and the second expansion valve and via a pass through the additional heat exchange line.

Certain embodiments of the invention may also relate to a method for liquefying cryogenic gas, for example liquefied hydrogen, using a production installation comprising a feed gas supply circuit comprising an upstream end connected to a gas source and a downstream end connected to at least one cryogenic store, the installation comprising a set of heat exchangers in heat exchange with the supply circuit and at least one cooling device in heat exchange with some or all of the set of heat exchangers, the at least one cooling device comprising a cryogenic refrigerator with a cycle gas comprising at least one of the following: helium, hydrogen, neon, nitrogen, oxygen or methane, the downstream end of the supply circuit comprising, between the set of heat exchangers and the second end, a final expansion turbine for the liquefied gas, the method comprising: a step of cooling a feed gas flow circulating in the supply circuit by heat exchange with the set of heat exchangers cooled by the at least one cooling device to a temperature below the critical temperature of the feed gas or below the bubble point temperature of the feed gas, and a main expansion step of this feed gas flow cooled and liquefied in the final expansion turbine to produce a liquid flow at a pressure greater than the saturation pressure or bubble point pressure of said feed gas to produce preferably only an entirely liquid phase, or a back-up expansion step of this feed gas flow cooled in the first expansion valve and in the second expansion valve bypassing the final expansion turbine, and a cooling by heat exchange with a heat exchanger of the set of heat exchangers between the expansions in the first expansion valve and the second expansion valve.

According to other possible distinguishing features:
in the main expansion step, the pressure ratio of the fluid between the upstream and downstream ends of the final expansion turbine is between five and twenty, preferably between five and ten,
in the back-up expansion step, the cooled feed gas flow is expanded in the first expansion valve or in the second expansion valve with a pressure ratio between five and twenty and preferably between five and ten to produce a fluid in the liquid state at the outlet of said valve,
the method includes two successive passes of the feed gas flow through a single heat exchanger of the set of heat exchangers that is located upstream of the final expansion turbine,
the method includes a step of switching between the main expansion step and the back-up expansion step, for example as a function of whether the final expansion turbine is running or stopped,
the method includes a step of switching from the main expansion step to the back-up expansion step during which the feed gas flow gradually bypasses the final expansion turbine and the supply of cooled feed gas to the final expansion turbine is interrupted and a pressure drop is generated by the second expansion valve,
the feed gas is hydrogen and/or helium, the cooling device comprising a refrigerator with a cycle gas comprising hydrogen and/or helium,
the feed gas is hydrogen, the method including a step of converting ortho-hydrogen into para-hydrogen in and/or downstream of a pass through a heat exchanger of the set of exchangers,
the method includes an additional isenthalpic expansion step of the feed gas downstream of the final expansion turbine with a pressure ratio between 1.05 and five, preferably within the range 1.3 to 2.7.

The invention may also relate to any alternative device or method comprising any combination of the features above or below within the scope of the claims.

Further distinctive features and advantages will become apparent on reading the description below, provided with reference to the figures, in which:

### BRIEF DESCRIPTION OF THE DRAWINGS

Other features and advantages of the invention will become further apparent via, on the one hand, the following description and, on the other hand, several exemplary embodiments given by way of non-limiting indication and with reference to the attached schematic drawings, in which:

FIG. 1 is a simplified schematic view of the structure and operation of an installation for producing cryogenic liquefied gas according to a first embodiment,

FIG. 2 is a partial schematic view of the structure and operation of an installation for producing cryogenic liquefied gas according to a second embodiment,

FIG. 3 is a partial schematic view of the structure and operation of an installation for producing cryogenic liquefied gas according to a third embodiment.

### DETAILED DESCRIPTION OF THE INVENTION

Throughout the figures, the same reference signs relate to the same elements.

In this detailed description, the following embodiments are examples. Although the description refers to one or more embodiments, this does not mean that the features apply only to a single embodiment. Individual features of different embodiments may also be combined and/or interchanged in order to provide other embodiments.

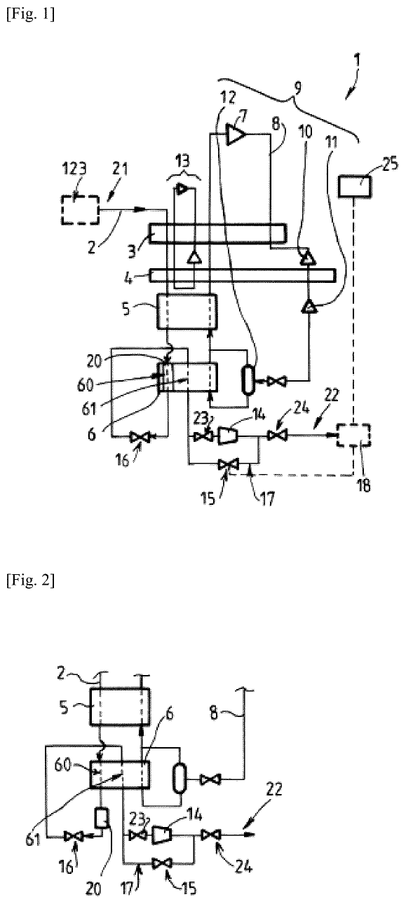

The installation 1 for producing cryogenic liquefied gas shown in [FIG. 1] comprises a circuit 2 for supplying feed gas to be cooled (for example hydrogen or helium). This supply circuit 2 comprises an upstream end 21 intended to be connected to a gas source 123 (for example an electrolyser or any other suitable source) and a downstream end 22 intended to be connected to at least one cryogenic store 18 for collecting and storing the liquefied gas.

The installation 1 comprises a set of heat exchangers 3, 4, 5, 6 in heat exchange with the supply circuit 2 and at least one cooling device in heat exchange with some or all of the set of heat exchangers.

The at least one cooling device is designed to produce a cooling power that is used to cool the gas in the supply circuit 2 indirectly via the heat exchanger or exchangers.

The at least one cooling device preferably comprises a cryogenic refrigerator 9 with a cycle gas comprising at least one of the following: helium, hydrogen, neon, nitrogen, oxygen or methane.

The cooling device 9 preferably comprises a refrigerator with a cycle gas comprising hydrogen and/or helium. The cycle gas can be subjected conventionally to a thermodynamic cycle 8 comprising a compression in a compression mechanism (compressor or compressors) 7, a cooling of the compressed gas (heat exchanger or exchangers 3, 4, 5, 6), an expansion of the cooled compressed gas (turbine or turbines 10 and/or valve or valves) 11 and a heating of the expanded gas (heat exchanger or exchangers 6, 5, 4, 3). As illustrated schematically, the cycle circuit 8 may include at least a phase separator vessel 12 and/or a thermosiphon system.

As illustrated, the installation 1 may further include an additional cooling device 13 designed to pre-cool the gas in the supply circuit 2 to an intermediate temperature. The aforementioned cryogenic refrigerator 9 can thus provide the cooling from the intermediate temperature to the final liquefaction temperature.

The additional cooling device 13 (pre-cooling) may comprise a cold-fluid loop (nitrogen) or a cycle-circuit refrigerator in which the cycle gas is nitrogen, or a mixture of refrigerant gases (MR) for example. The installation 1 may comprise more than two cooling devices.

As illustrated, the downstream end 22 of the supply circuit 2 comprises, between the set of heat exchangers 3, 4, 5, 6 and the second end 22 intended to be connected to the store 18, a final expansion turbine 14 designed to expand the cooled feed gas in liquid state. In other words, at the inlet of the final expansion turbine 14, the feed gas has been conveyed in liquid form (pressure below critical pressure and temperature below saturation temperature, saturation temperature defining the boundary temperature between the liquid state and the gas state) or is conveyed to the inlet of the final expansion turbine 14 in dense supercritical form (pressure greater than critical pressure and temperature below critical temperature).

At the outlet of the turbine 14, the expanded fluid is at least partially in liquid form.

This final expansion turbine 14 is thus disposed downstream of the last heat exchanger 6 of the set of exchangers in series from upstream to downstream.

The supply circuit 2 further comprises a bypass line 17 of the final expansion turbine 14 fitted with a first expansion valve 15, preferably a Joule-Thomson valve.

As illustrated, the supply circuit 2 may comprise a regulating member 23 disposed at the inlet of the final expansion turbine 14 and designed to regulate the pressure and/or flow rate in the circuit 2 and/or the rotation speed of said turbine 14. This regulating member 23 for example comprises or consists of a valve. The bypass line 17 of the expansion turbine 14 also preferably bypasses this pressure and/or flow rate regulating member 23.

Furthermore, the supply circuit 2 comprises a second expansion valve 16, preferably a Joule-Thomson valve, disposed in series upstream of the first expansion valve 15 and of the final expansion turbine 14. The supply circuit 2 also comprises an additional heat exchange line 61 designed to exchange heat with a heat exchanger 6 of the set of heat exchangers after passing through the second expansion valve 16 and before entering the final expansion turbine 14 or the first expansion valve 15. In other words, the additional heat exchange line 61 is designed to carry out this heat exchange with said heat exchanger 6 between the expansion carried out by the second expansion valve 16 and the expansion carried out by the first expansion valve 15.

The additional heat exchange line 61 is in this example located upstream of the expansion carried out by the first expansion valve 15.

Thus, according to this architecture, when the final expansion turbine 14 is operational, this turbine can expand the previously liquefied gas to produce subcooled liquid.

For example, during a main expansion, the cooled feed gas flow (typically hydrogen) is expanded in the final expansion turbine 14 to produce a liquid flow at a pressure greater than the saturation pressure of said feed gas to produce preferably only an entirely liquid phase. In this main expansion, the pressure ratio of the fluid between the upstream and downstream ends of the final expansion turbine 14 is preferably between five and twenty, preferably between five and ten.

If the final expansion turbine 14 is not available (for example during maintenance), the liquid in the supply circuit 2, once it has been expanded in the second expansion valve 16 and passed through the additional heat exchange line 61, is expanded in the first expansion valve 15 of the bypass line. This produces a subcooled liquid, limiting flash downstream.

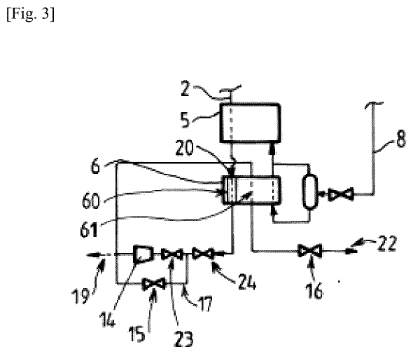

Thus, where the final expansion turbine 14 is bypassed, the pressure and/or the flow rate can be controlled by the second expansion valve 16 between the passes 60, 61 through the end exchanger 6 (as shown in [FIG. 1] and [FIG. 2]) or by the valve 15 (as shown in [FIG. 3]).

For example, during this back-up expansion, the feed gas flow cooled and expanded in the second expansion valve 16 then undergoes a cooling by heat exchange with the heat exchanger 6, and is then expanded in the first expansion valve 15, bypassing the final expansion turbine 14.

This allows the installation to be operated without the final expansion turbine 14 while preserving thermodynamic conditions in the produced liquid that limit the risk of vaporization (flash).

In this back-up expansion, the cooled feed gas flow is expanded in the first expansion valve 15 (and/or in the second expansion valve 16) with a pressure ratio preferably between five and twenty and preferably between five and ten to output a fluid in the liquid state.

As illustrated, the heat exchanger 6 in heat exchange with the additional heat exchange line 6 can be the downstream end exchanger 6 of the set of heat exchangers 3, 4, 5, 6 in series, of which an outlet is connected to the inlet of the final expansion turbine 14.

Furthermore and as illustrated, the supply circuit 2 may make two successive distinct passes 60, 61 through the same end exchanger 6 (two distinct exchange lines), the additional heat exchange line constituting one pass 61 of the two passes. In other words, the supply circuit 2 may comprise, disposed in series in this order from upstream to downstream: a first pass 60 of the two passes through the end exchanger 6, the second expansion valve 16, the second pass 61 of the two passes through the end exchanger 6, the final expansion turbine 14 with the bypass line 17 thereof fitted with the first expansion valve 15, and the second end.

The supply circuit 2 preferably comprises at least one catalysis section 20 designed to convert the ortho-hydrogen into para-hydrogen. For example, the one or more catalysis sections 20 is/are designed to mainly convert hydrogen into para-hydrogen (ortho-to-para conversion), for example above 80% or above 85% or above 95% for example 99% para at the outlet of the catalysis section 20.

This catalysis section 20 can be located in at least one of the two passes 60, 61 through the end exchanger 6, for example in the first pass 60.

Furthermore, the supply circuit 2 may comprise a third expansion valve 24, preferably a Joule-Thomson valve, disposed in series with the first expansion valve 15 and the second expansion valve 16. In this example, this third expansion valve 24 is located downstream of the final expansion turbine 17 and of the bypass line 17. This third expansion valve 24 enables an additional isenthalpic expansion of the feed gas downstream of the final expansion turbine 14 with a pressure ratio preferably between 1.05 and five, preferably within the range 1.3 to 2.7.

As shown schematically in [FIG. 1], the installation 1 may comprise a control system 25 designed to switch the installation 1 to a first operating mode in which the bypass line 17 is closed and liquefied cryogenic fluid is produced via an expansion in the final expansion turbine 14, or to a second operating mode in which the bypass line 17 is open and the final expansion turbine 14 is stopped and liquefied cryogenic fluid is produced via a double expansion via the second expansion valve 16 and the first expansion valve 15 and via a pass through the additional heat exchange line 61. The control system 25 may for example include an electronic control member comprising a microprocessor and configured to control some or all of the valves and in particular a valve enabling the final expansion turbine 14 to be bypassed in favour of the first expansion valve 15. This switching may be manual or in response to a signal representing the operating state of the final expansion turbine 14. Naturally, the control system 25 may be at least partially manual.

The switching may be activated for example manually, for example during transitory phases such as start-ups or stoppages of the installation and/or automatically if the temperature of the fluid at a given point of the installation is too high. For example, if the temperature at the outlet of the first pass 60 (measured or estimated or deduced from another measurement reflecting this temperature, for example a pressure, a level and/or a temperature at another location of the refrigeration cycle) exceeds a given threshold.

For example, in the first embodiment, most of the expansion of the fluid can be carried out in the final expansion turbine 14 and the remainder of the expansion can be carried out downstream of said turbine 14 (via the third expansion valve 24, see [FIG. 1] and [FIG. 2] or via the second expansion valve 16, see [FIG. 3]). These expansions are designed to produce a 100% liquid flow at the outlet of the final expansion turbine 14. In the embodiment in [FIG. 3], most of the expansion can be carried out between the two passes 60 and 61.

Preferably, when switching from a main expansion to a back-up expansion, the first expansion valve 15 s controlled to gradually bypass the final expansion turbine 14 before interrupting the supply of cooled feed gas to the final expansion turbine 14. For example, a pressure drop is generated by the second expansion valve 16. The switching is preferably completed in less than 10 minutes.

For example, if the final expansion turbine 14 is stopped, the installation 1 can first command the bypass line 17 of the turbine 14 to be opened and can close the valve 23 located at the inlet of the turbine 14. The first expansion valve 15 is then opened gradually and the pressure drop is controlled (created) by the valve 24, for example.

The embodiment in [FIG. 2] differs from the embodiment described previously only in that the catalysis section 20 is located at the outlet of the first pass 60 in the end heat exchanger 6 (in a tank upstream of the second expansion valve 16). The conversion is then carried out outside the exchanger in a tank 20 in which the catalyst is placed. This adiabatic conversion is also exothermic (as in continuous conversion). The fluid is then heated in the tank 20 and then returns to the end heat exchanger 6 to be cooled (in the second pass 61).

In the embodiment in [FIG. 3], the supply circuit 2 comprises, disposed in series in this order from upstream to downstream: a first pass 60 of the two passes through the end heat exchanger 6, the third expansion valve 24, the final expansion turbine 14 with the bypass line 17 thereof fitted with the first expansion valve 15, the second pass 61 of the two passes through the end exchanger 6, then the second expansion valve 16, and the second end 22. In this embodiment, the third expansion valve 24 can also be omitted and the function thereof can in this case be performed by the first expansion valve 15.

In this configuration, the fluid in the supply circuit 2 can be cooled and liquefied (or densified if at a pressure greater than the critical pressure of the component) by indirect heat exchange with the refrigerator 9 in the heat exchanger 6 during the first pass 60. This cold supply flow in dense liquid or supercritical phase is then expanded through the final expansion turbine 14 to a pressure high enough to prevent the production of a vapour phase in the output flow. The fluid expanded by the turbine 14 is entirely liquid. Preferably upstream of the final expansion turbine 14, a valve 23 (for example a throttle valve) may be used to control the rotation speed of the final expansion turbine 17.

As illustrated, the supply circuit 2 may comprise, between the outlet of the final expansion turbine 14 and the bypass line 17 thereof on one side and the second pass 61 of the two passes through the end exchanger 6 on the other side, a bypass line 19 designed to recover the fluid directly at the outlet of the final expansion turbine 14 (or from the bypass), i.e. without passing through the second pass 61 of the two passes through the end exchanger 6 (see [FIG. 3]).

The flow produced at the outlet of the final expansion turbine 14 (or of the bypass) can either be made available directly via the bypass line 19 or returned to a heat exchanger 16 (usually the same heat exchanger as illustrated) to be further cooled and stored (following expansion in the second expansion valve 16). For example, a part of the fluid produced at the outlet of the final expansion turbine 14 is conveyed in this bypass line 19, the remainder of the flow being conveyed through the second pass 61.

The pressure of the output flow from the final expansion turbine 14 (or from the bypass line 17) can be set to a pressure high enough to prevent the production of a vapour phase in the flow 4 having to return to the heat exchanger 6 for the second pass.

The expansion rates of the first expansion valve 15 and the second expansion valve 16 (i.e. the intermediate pressure upstream of the second expansion valve 16) may be adjusted to prevent (or limit) the production of a vapour phase in the flow making the second pass 61 through the heat exchanger 6. This simplifies the design of the injection of this flow into the heat exchanger 6 (no need for a phase separator vessel and/or a two phase injection system).

The final cooling by indirect heat exchange of the flow during the second pass 61 enables the temperature of the final liquid product to be monitored at all times. The downstream valve 16, 24 enables the fluid to be expanded to a pressure close to (in consideration of the pressure drop along the lines and the equipment) the operating pressure of the liquid store intended to receive the liquid.

The first expansion valve 15 thus enables back-up operation without the final expansion turbine 14 while controlling the delivery temperature using the final cooling step of the flow. This solution enables the use of a final expansion turbine 14 without jeopardizing the availability of the installation 1 in the event of a possible malfunction or outage of the turbine 14. The last heat exchange (second pass 61) can be carried out at least partially with the same refrigerant fluid as the cooling of the main process gas flow.

The thermodynamic conditions (temperature and pressure) of the liquid produced via the final expansion turbine 14 or via the bypass line 17 may be similar.

The output pressure of the final expansion turbine 14 can be adjusted by the dedicated expansion valve 16, 24 upstream or downstream to protect the turbine from any vapour phase produced.

In particular, the third expansion valve 24 ([FIG. 1] and [FIG. 2] or valve 16 in [FIG. 3]) can be controlled to provide a backpressure downstream of the turbine 14 to prevent flash gas, in particular when bypassing the final expansion turbine 14. This valve 24 may be designed to ensure a minimum acceptable output pressure from the turbine 14.

The pressure of the fluid at the outlet of the final expansion turbine 14 may for example be kept at a pressure level that is 0.1 to several bars greater than the saturation pressure of the fluid.

The installation may comprise a sensor for measuring the delivery pressure at the outlet of the final expansion turbine 14 and the installation may be designed to regulate the pressure of the fluid at the outlet of the final expansion turbine 14 as a function of the measured pressure. The installation may comprise a sensor for measuring the temperature of the fluid at the outlet and/or at the inlet of the final expansion turbine, the delivery pressure being regulated as a function of the measured temperature.

The temperature of the fluid at the outlet of the final expansion turbine 14 may be between 15and 30 K, preferably between 20 and 25 K.

Joule-Thomson expansion valve for example refers to an isenthalpic expansion element in which the flow area may be increased or reduced. This means that the fluid can be heated or cooled in this valve as a function of the input pressure and temperature conditions and the characteristics of the gas (notably the temperature inversion curve thereof, in particular in the case of hydrogen).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed.

Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. An installation for producing liquid hydrogen, the installation comprising:
a supply circuit configured to supply a feed gas to be cooled, the supply circuit comprising an upstream end configured to be connected to a gas source and a downstream end configured to be connected to at least one cryogenic store designed to collect and store the liquid hydrogen;
a set of heat exchangers in heat exchange with the supply circuit,
at least one cooling device in heat exchange with some or all of the set of heat exchangers, the at least one cooling device comprising a cryogenic refrigerator with a cycle gas comprising at least one of the following: helium, hydrogen, neon, nitrogen, oxygen or methane,
a final expansion turbine disposed downstream of the set of heat exchangers, wherein the final expansion turbine is configured to expand the feed gas that is in liquid state at the inlet of said final expansion turbine,
a bypass line of the final expansion turbine fitted with a first expansion valve,
a second expansion valve disposed in series upstream or respectively downstream of the first expansion valve and of the final expansion turbine,
an additional heat exchange line configured to exchange heat with at least one of the heat exchangers of the set of heat exchangers when the feed gas is expanded by the first expansion valve via the bypass line,
wherein the additional heat exchange line is configured to carry out said heat exchange with said the at least one of the heat exchangers between the expansion carried out by the first expansion valve and the expansion carried out by the second expansion valve, the additional heat exchange line being located upstream or respectively downstream of the expansion carried out by the first expansion valve, and in that the heat exchanger in heat exchange with the additional heat exchange line is the last exchanger of the set of heat exchangers in series, of which an outlet is connected to the inlet of the final expansion turbine, and
wherein the supply circuit forms two successive distinct passes through the end exchanger of the set of exchangers, the additional heat exchange line constituting one pass of the two passes.

2. The installation according to claim 1, wherein the supply circuit comprises, disposed in series in this order from upstream to downstream: a first pass of the two passes through the end exchanger, the second expansion valve, the second pass of the two passes through the end exchanger, the final expansion turbine with the bypass line thereof fitted with the first expansion valve, and the second end.

3. The installation according to claim 1, wherein the supply circuit comprises, disposed in series in this order from upstream to downstream: a first pass of the two passes through the end exchanger, the final expansion turbine with the bypass line thereof fitted with the first expansion valve, the second pass of the two passes through the end exchanger, the second expansion valve, and the second end.

4. The installation according to claim 3, wherein the supply circuit comprises, between the final expansion turbine and the bypass line thereof on one side and the second pass of the two passes through the end exchanger on the other side, a bypass line designed to recover the fluid at the outlet of the final expansion turbine without passing through the second pass of the two passes through the end exchanger.

5. The installation according to claim 1, wherein the supply circuit comprises at least one catalysis section designed to convert the ortho-hydrogen into para-hydrogen, the catalysis section being located in at least one of the two passes through the end exchanger, for example in the first pass and/or outside the end exchanger, at the outlet of one of the two passes through the end exchanger.

6. The installation according to claim 1, wherein the supply circuit comprises a third expansion valve, preferably a Joule-Thomson valve, disposed in series with the first expansion valve and second expansion valve.

7. The installation according to claim 6, wherein the third expansion valve is disposed downstream or upstream of the first expansion valve.

8. The installation according to claim 1, further comprising a regulating member disposed at the inlet of the final expansion turbine and designed to regulate the pressure and/or the flow rate in the supply circuit and/or the rotation speed of said turbine, the bypass line of the expansion turbine also bypassing this regulating member.

9. The installation according to claim 1, further comprising a control system configured to switch the installation to a first operating mode in which the bypass line is closed and liquefied cryogenic fluid is produced via an expansion in the final expansion turbine, and also switch the installation to a second operating mode in which the bypass line is open and the final expansion turbine is stopped and liquefied cryogenic fluid is produced via a double expansion via the first expansion valve and the second expansion valve and via a pass through the additional heat exchange line.

10. A method for liquefying hydrogen: the method comprising the steps of:
providing a production installation comprising a feed gas supply circuit comprising an upstream end connected to a gas source and a downstream end connected to at least one cryogenic store, the production installation comprising a set of heat exchangers in heat exchange with the supply circuit and at least one cooling device in heat exchange with some or all of the set of heat exchangers, the at least one cooling device comprising a cryogenic refrigerator with a cycle gas comprising at least one of the following: helium, hydrogen, neon, nitrogen, oxygen or methane, the downstream end of the supply circuit comprising, between the set of heat exchangers and the second end, a final expansion turbine for the liquefied gas; and
cooling a feed gas flow circulating in the supply circuit by heat exchange with the set of heat exchangers cooled by the at least one cooling device to a temperature below the critical temperature of the feed gas or below the bubble point temperature of the feed gas,
wherein the method comprises a first mode of operation and a second mode of operation,
wherein, during the first mode of operation, the method includes the step of expanding said feed gas flow cooled and liquefied in the final expansion turbine to produce a liquid flow at a pressure greater than the saturation pressure or bubble point pressure of said feed gas to produce preferably only an entirely liquid phase;
wherein, during the second mode of operation, the method includes the step of expanding said feed gas flow cooled in a first expansion valve and in the second expansion valve bypassing the final expansion turbine, and a cooling by heat exchange with a heat exchanger of the set of heat exchangers between the expansions in the first expansion valve and the second expansion valve,
wherein the method further includes two successive passes of the feed gas flow through a single heat exchanger of the set of heat exchangers that is located upstream of the final expansion turbine.

11. The liquefaction method according to claim 10, wherein, in the first mode of operation, the pressure ratio of the fluid between the upstream and downstream ends of the final expansion turbine is between five and twenty, preferably between five and ten.

12. The liquefaction method according to claim 10, wherein, in the second mode of operation, the cooled feed gas flow is expanded in the first expansion valve or in the second expansion valve with a pressure ratio between five and twenty and preferably between five and ten to produce a fluid in the liquid state at the outlet of said valve.

13. The liquefaction method according to claim 10, further comprising switching between the first mode of operation and the second mode of operation, for example as a function of whether the final expansion turbine is running or stopped.

14. The liquefaction method according to claim 13, further comprising switching from the first mode of operation to the second mode of operation during which the feed gas flow gradually bypasses the final expansion turbine and the supply of cooled feed gas to the final expansion turbine is interrupted and a pressure drop is generated by the second expansion valve.

15. The liquefaction method according to claim 10, wherein the feed gas is hydrogen and/or helium, the cooling device comprising a refrigerator with a cycle gas comprising hydrogen and/or helium.

16. The liquefaction method according to claim 10, wherein the feed gas is hydrogen, the method including a step of converting ortho-hydrogen into para-hydrogen in and/or downstream of a pass through a heat exchanger of the set of exchangers.

17. The liquefaction method according to claim 10, further comprising an additional isenthalpic expansion step of the feed gas downstream of the final expansion turbine with a pressure ratio between 1.05 and five, preferably within the range 1.3 to 2.7.
